(19) United States
(12) Patent Application Publication
(10) Pub. No.: US 2017/0320040 A1
(43) Pub. Date: Nov. 9, 2017

(54) METHODS AND KITS FOR REMOVING ORGANIC POLLUTANTS FROM A CONTAMINATED SAMPLE

(71) Applicant: Trustees of Tufts College, Medford, MA (US)

(72) Inventors: Albert Robbat, JR., Andover, MA (US); Nicholas M. Wilton, Newton, MA (US); Christian David Zeigler, Medford, MA (US)

(73) Assignee: Trustees of Tufts College, Medford, MA (US)

(21) Appl. No.: 15/587,965

(22) Filed: May 5, 2017

Related U.S. Application Data
(60) Provisional application No. 62/332,242, filed on May 5, 2016.

(51) Int. Cl. B01J 20/26; C02F 1/68; B01J 20/28; B08B 3/10; B08B 3/08; B09C 1/08; C02F 1/28; C02F 101/32

(52) U.S. Cl. CPC B01J 20/261; B09C 1/08; C02F 1/68; C02F 1/285; B01J 20/28011; B08B 3/104; B08B 3/08; C02F 2101/32

(57) ABSTRACT

Methods and kits for the removal of organic contaminants from contaminated samples are generally provided. In some embodiments, the methods and kits comprise a surfactant and adsorbent particles.

### RELATED APPLICATIONS

This application claims the benefit, under 35 U.S.C. §119(e), of U.S. Provisional Patent Application Ser. No. 62/332,242, entitled “Methods and Kits for Removing Organic Pollutants from a Contaminated Sample,” filed on May 5, 2016, the contents of which are incorporated herein by reference in their entirety.

### FIELD

Methods and kits for removing organic contaminants from a contaminated sample are generally provided.

### BACKGROUND

Naturally occurring and unintended coal tar and petroleum seepages from manufacture, collection, transport and storage activities pose a significant risk to human health and the environment. One of the major obstacles encountered in the remediation of contaminated sites is the lack of cost-effective and/or high efficiency technologies for treatment of impacted soils, sediment and water. Accordingly, improved methods and kits for removing organic pollutants from contaminated materials are needed.

### SUMMARY

The present disclosure relates to methods and kits for removing organic contaminants from a contaminated sample. The subject matter of the present invention involves, in some cases, interrelated products, alternative solutions to a particular problem, and/or a plurality of different uses of one or more systems and/or articles.

In one aspect, methods of removing organic contaminants from contaminated samples are described. In some embodiments, the method comprises agitating a contaminated sample, surfactant, and adsorbent particles, wherein the contaminated sample comprises a solid or liquid material and organic contaminants; and removing at least a portion of the organic contaminants from the contaminated sample, thereby producing a cleaned sample.

Certain aspects are related to inventive kits. In some embodiments, the kit comprises a surfactant and a plurality of adsorbent particles.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosures, the present specification shall control. If two or more documents incorporated by reference include conflicting and/or inconsistent disclosures with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows in accordance with some embodiments, a schematic illustration of a method of removing organic contaminants from a contaminated sample within a vessel;

FIG. 1B shows according to certain embodiments, a schematic illustration of a cleaned sample from which organic contaminants and adsorbent particles have been removed;

FIG. 1C shows in accordance with some embodiments, a schematic illustration of a cleaned sample from which organic contaminants, adsorbent particles, and surfactant have been removed;

FIG. 2A shows an exemplary schematic illustration of agitation using a rotary mixer system;

FIG. 2B shows, according to certain embodiments, a schematic illustration of agitation using a completely mixed reactor system;

FIG. 3 shows a schematic illustration of a kit comprising adsorbent particles and a surfactant, according to certain embodiments;

FIG. 4 shows a picture of the impact of coal tar in a river after 70 years of weathering, according to one set of embodiments;

FIG. 5 shows a surface response map of surfactant concentration vs. surfactant volume:sediment mass ratio (mL:g), in accordance with some embodiments;

FIG. 6 shows a surface response map of polystyrene foam pellet (PFP) mass:sediment mass ratio (g:g) vs. surfactant volume:sediment mass ratio (mL:g), in accordance with certain embodiments;

FIG. 7 shows, according to certain embodiments, a surface response map of agitation time (hrs) vs. PFP mass:sediment mass ratio (g:g);

FIG. 8 shows, in accordance with certain embodiments, a photograph of river sediment before treatment;

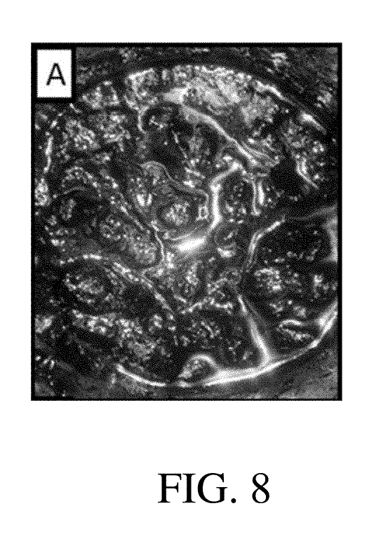

FIG. 9 shows a photograph of the same river sediment after treatment, according to some embodiments;

FIG. 10 shows a photograph of polystyrene foam pellets before treatment, according to certain embodiments;

FIG. 11 shows, in accordance with some embodiments, a photograph of polystyrene foam pellets after treatment of the same river sediment;

FIG. 12 shows an SEM image of polystyrene foam before treatment of the same river sediment, according to certain embodiments;

FIG. 13 is an SEM image of polystyrene foam after treatment of the same river sediment, in accordance with some embodiments; and

FIG. 14 shows, according to some embodiments, an illustration of pi-pi attractive forces between coal tar components (e.g., PAH) and polystyrene.

### DETAILED DESCRIPTION

The present disclosure generally provides methods and kits for removing organic contaminants from a contaminated sample. Advantageously, the kits and methods described herein may offer one or more advantages over other methods and kits for removing organic contaminants from contaminated samples, including, but not limited to, reductions in cost and/or increased efficiency of contaminant removal.

In some embodiments, methods of removing organic contaminants from a contaminated sample are provided. In some embodiments, the method comprises agitating a surfactant, a plurality of adsorbent particles, and a contaminated liquid or solid sample, wherein at least a portion of the organic contaminants are removed from the contaminated liquid or solid sample, thereby forming a cleaned sample. According to certain embodiments, the organic contaminants may be mobilized or solubilized by the surfactant (which, in some embodiments, serves as an extractant) and adsorbed by the adsorbent particles. The adsorbent particles and the adsorbed contaminants can then be removed from the sample in some embodiments thereby forming a cleaned sample. Non-limiting examples of contaminated materials include water, soil, and/or sediment. In certain embodiments, the organic contaminants may comprise tar and/or crude oil.

The methods for removing organic contaminants may be performed in situ and/or may be performed on samples which have been removed from their initial locations and optionally transported to a different location, ex situ.

In some embodiments, kits for removing organic contaminants from a contaminated sample are provided. The kits may comprise a surfactant and adsorbent particles. The kits may be used in the methods described herein.

The methods and kits described herein may have certain advantages over other methods and kits capable of cleaning contaminated samples. For example, the methods and/or kits of this invention may be capable of removing a large percentage of organic contaminants from a contaminated sample. According to certain embodiments, the combination of the surfactant and the adsorbent particles is capable of removing a greater amount of organic contaminants from a contaminated sample than either component alone. In some embodiments, the contaminated sample may comprise more than one species of organic contaminant. It should be understood that any references herein to organic contaminant removal and/or efficiency of organic contaminant removal may refer to the removal of one or more individual species of organic contaminant and/or to the removal of the sum total of all organic contaminants.

In some embodiments, the methods and kits described herein may be capable of removing greater than or equal to about 50%, greater than or equal to about 75%, greater than or equal to about 80%, greater than or equal to about 85%, greater than or equal to about 90%, greater than or equal to about 95%, greater than or equal to about 96%, greater than or equal to about 97%, greater than or equal to about 98%, greater than or equal to about 99%, greater than or equal to about 99.5%, or essentially all of the organic contaminants from a contaminated sample. The percentage of organic contaminants removed from a sample may be determined by dividing the amount of contaminants in the cleaned sample by the amount of contaminants in the contaminated sample and multiplying by 100%. Those of ordinary skill in the art will be aware of methods for determining the amount of organic contaminants in a sample (e.g., either a contaminated sample or a cleaned sample).

In certain embodiments, the amount of organic contaminants in a sample may be determined by extracting the organic contaminants from the sample and then analyzing the extracted organic contaminants. According to some embodiments, organic contaminants may be extracted with the aid of an organic solvent such as dichloromethane or toluene and then analyzed by GC/MS and/or any other analytical chemistry instrument. In accordance with certain embodiments, internal standards may be used to determine the concentration of the organic contaminants within the extracting solvent and/or surrogate standards may be used to assess sample preparation and recovery.

In some embodiments, the methods and kits described herein may allow for removal of organic contaminants from a contaminated sample at a reduced cost in comparison to organic contaminant removal by other methods. Examples of methods that the methods and kits of this invention may provide a cost savings over include: methods comprising the steps of dredging, stabilizing, transporting, and landfilling organic contaminants; methods comprising the steps of dredging, stabilizing, transporting, and incinerating organic contaminants; methods comprising solidifying organic contaminants in place using stabilizing agents and cement; methods comprising bioremediation; and/or methods comprising soil washing.

Methods of removing organic contaminants from a contaminated sample will now be described in more detail. Generally, the methods involved agitating a surfactant, a plurality of adsorbent particles, and a contaminated liquid or solid sample. The method may be carried out at the site of contamination or the contaminated sample may be removed from the site of contamination prior to carrying out the method. For example, in some embodiments, the method of removing the organic contaminants may be carried out at the site of the contamination (e.g., in a riverbed), wherein the surfactant and the adsorbent particles are provided directly to the site (e.g., to the riverbed). In certain embodiments, organic contaminants may be sheared from solids by agitation without mixing. Shearing may comprise using an eductor pump to mix liquids and solids in some embodiments. According to certain embodiments, pressurized media comprising liquids and solids may enter an eductor pump through a pressure nozzle which causes the formation of a high velocity jet. Then, in some embodiments, a vacuum may be applied to cause the liquid to flow into the body and/or throat of the educator where it may be entrained and aggressively mixed. At this point, organic contaminants which are attached to solids may be sheared and separated from the solids. In accordance with certain embodiments, the presence of surfactant during this process may liberate any retained organic contaminants from the solids.

As another example, in other embodiments, the contaminated sample may be removed from the site of contamination prior to carrying out the method. For example, contaminated soil may be removed from a riverbed and the method may be carried out in a vessel, wherein the sample is agitated in the vessel. During agitation, the organic contaminants may be mobilized by the surfactant and then adsorbed by the adsorbent particles. At least a portion of the organic contaminants may be removed by removing the adsorbent particles from the contaminated sample, thereby forming a cleaned sample. The cleaned sample may be further process and/or returned to the original site for disposal.

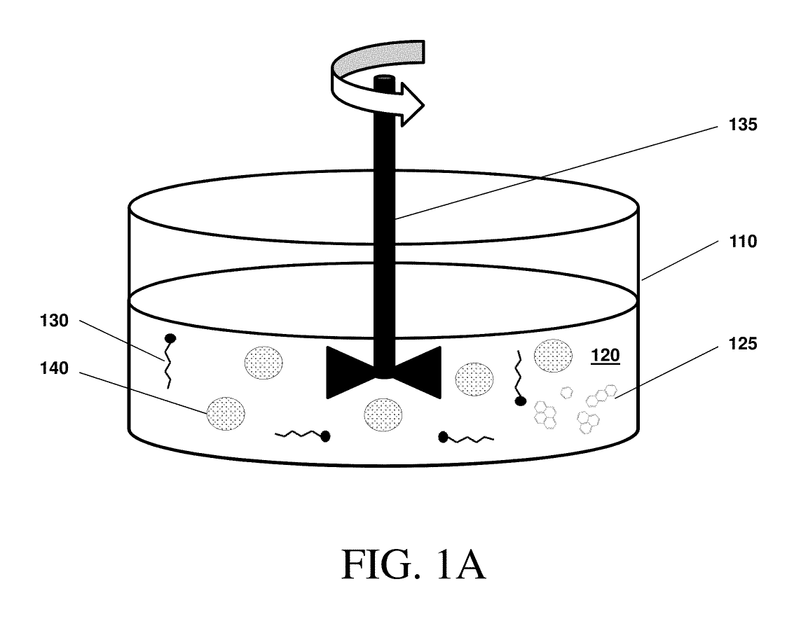

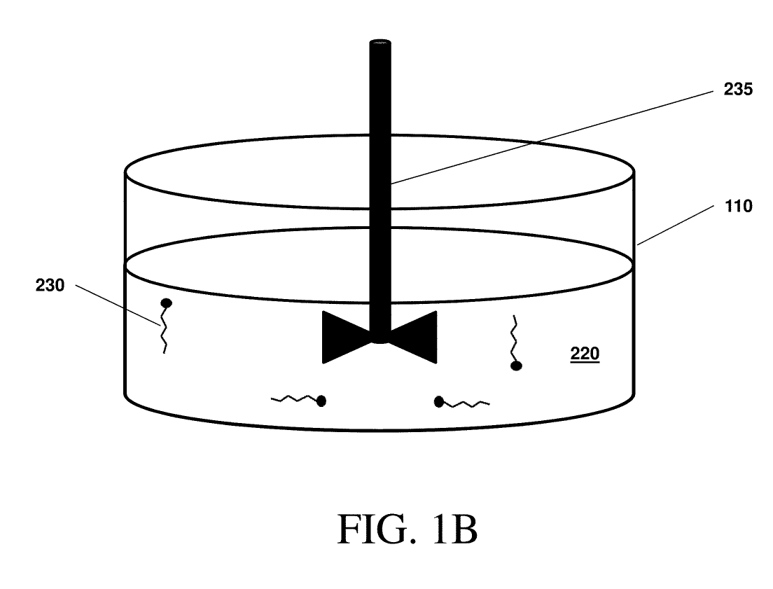

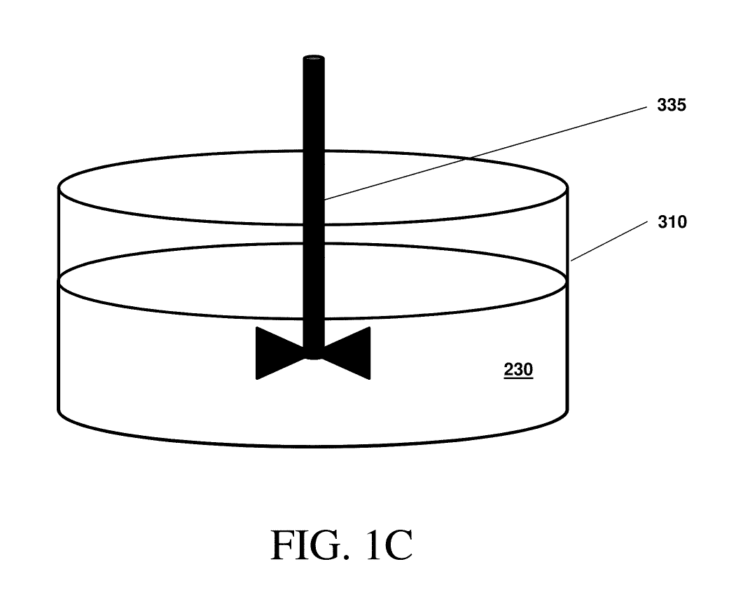

A non-limiting example of a method for removing organic contaminants from a contaminated sample in a vessel is shown in FIG. 1A, FIG. 1B, and FIG. 1C. The method comprises agitating a vessel 110 by means of a propeller 135, wherein vessel 110 comprises contaminated sample 120 comprising, surfactant 130, and adsorbent particles 140. Additional water or other solvents may also be provided to vessel 110 (organic contaminants 125). Organic contaminants 125 may be mobilized by surfactant 130 and then adsorb onto adsorbent particles 140. Then, according to some embodiments, adsorbent particles 140 may be removed from vessel 110 to yield a cleaned sample. Methods for removing the adsorbent particles are described herein. For example, FIG. 1B shows cleaned sample 220 in vessel 110, wherein the adsorbent particles 140 and organic contaminants 125 have been removed. In certain embodiments, surfactant 130 may also be removed from the cleaned sample, as shown in FIG. 1C. Suitable methods of removing the surfactant include, but are not limited to pumping the cleaned sample after solids have settled, centrifugation, using a hydrocyclone, and/or using a pancake press. Vessel 110 may be located onsite of the contamination or in another location from the site at some distance of contamination.

In some embodiments, methods for removing organic contaminants from contaminated samples may comprise agitating the contaminated sample, surfactant, and adsorbent particles. Agitation may cause mixing of the contaminated sample with the surfactant and adsorbent particles. As noted above, the agitation may occur at the site of contamination (e.g., in situ) and/or the sample may be removed from the site of contamination prior to agitation (e.g., ex situ).

In embodiments where the sample is removed from the site of contamination prior to agitation, the agitation may be conducted in a vessel on site (e.g., in a cement mixer located at a riverbed) or at another location (e.g., in a treatment facility). The contaminated sample, surfactant, and adsorbent particles may be introduced to a vessel and agitated, for example, using a rotary mixer and/or impeller reactor. The agitation may occur using a batch system or a flow-through system. Non-limiting examples of suitable batch systems for use during agitation include cement mixers and completely-mixed reactors. Non-limiting examples of suitable flow-through systems for use during agitation include rotary or trommel screens and completely-mixed flow through reactors.

In embodiments wherein the agitation is carried out in situ, the surfactant and adsorbent particles may be added to a body of water comprising the contaminated sample. Agitation may be effected by the use of any suitable device (e.g., manual or mechanical agitation, dredging).

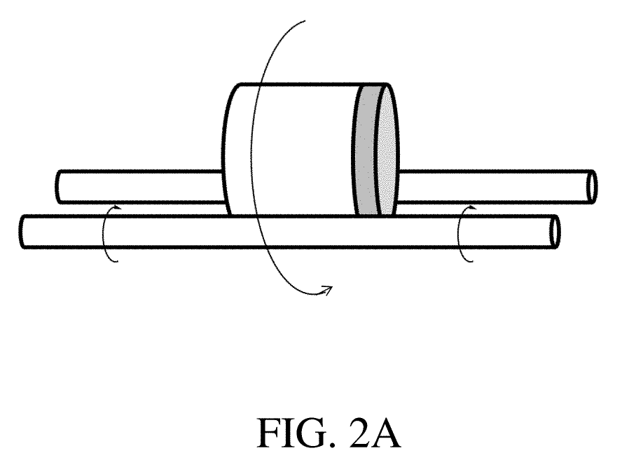

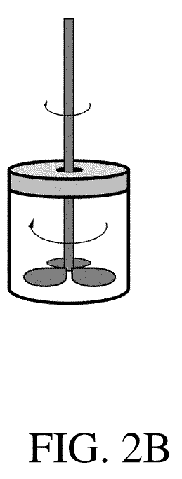

FIG. 2A-FIG. 2B show non-limiting methods of agitating the contaminated solution with a surfactant and the adsorbent particles in accordance with certain embodiments of the invention. FIG. 2A shows a rotary mixer system according to certain embodiments. FIG. 2B displays a completely mixed reactor system in accordance with some embodiments. In some embodiments, the method for agitating the sample may comprise providing the sample and other components to a cement mixer.

For example, as would be understood by a person of skill in the art, while FIG. 1A and FIG. 1B show agitation using a propeller, this is by no means limiting and other methods of agitation may be employed. For example, the method shown schematically in FIG. 1A and FIG. 1B may instead comprise agitation using a method that does not involve a propeller, such as rotary mixing (e.g., a cement mixer), shaking, using a fluidized bed reactor, sonication, and/or using a vortex mixer or educator pumps. The method shown in FIG. 1A and FIG. 1B may also comprise using multiple methods of agitation.

The sample may be agitated for any suitable period of time. In certain embodiments, agitation may occur for a time of greater than or equal to about 5 minutes, greater than or equal to about 10 minutes, greater than or equal to about 15 minutes, greater than or equal to about 30 minutes, greater than or equal to about 45 minutes, greater than or equal to about 60 minutes, greater than or equal to about 75 minutes, greater than or equal to about 90 minutes, greater than or equal to about 2 hours, greater than or equal to about 5 hours, greater than or equal to about 7 hours, or greater than or equal to about 10 hours. In some embodiments, agitation may occur for a time of less than or equal to about 12 hours, less than or equal to about 7 hours, less than or equal to about 5 hours, less than or equal to about 2 hours, less than or equal to about 90 minutes, less than or equal to about 75 minutes, less than or equal to about 60 minutes, less than or equal to about 45 minutes, less than or equal to about 30 minutes, less than or equal to about 15 minutes, or less than or equal to about 10 minutes. Combinations of the above-referenced ranges are possible (e.g., greater than or equal to about 30 minutes and less than or equal to about 2 hours). In some embodiments, the agitation occurs for a time period of greater than or equal to about 30 minutes and less than or equal to about 120 minutes. Other ranges are also possible. According to certain embodiments, increasing the agitation time may increase the efficiency of organic contaminant removal. For example, it may be possible to achieve increased removal rates by increasing the agitation time from 2 hours to 10 hours.

The agitation may be conducted at any desired speed. In some embodiments, agitation may occur at a speed of greater than or equal to about 50 rpm, greater than or equal to about 75 rpm, greater than or equal to about 90 rpm, greater than or equal to about 100 rpm, greater than or equal to about 200 rpm, greater than or equal to about 500 rpm, greater than or equal to about 750 rpm, greater than or equal to about 1,000 rpm, greater than or equal to about 2,500 rpm, greater than or equal to about 5,000 rpm, greater than or equal to about 10,000 rpm, greater than or equal to about 25,000 rpm, greater than or equal to about 50,000 rpm, or greater than or equal to about 100,000 rpm. According to some embodiments, the agitation may occur at a speed of less than or equal to about 125,000 rpm, less than or equal to about 100,000 rpm, less than or equal to about 50,000, less than or equal to about 25,000 rpm, less than or equal to about 10,000 rpm, less than or equal to about 5,000 rpm, less than or equal to about 2,500 rpm, less than or equal to about 1500 rpm, less than or equal to about 1000 rpm, less than or equal to about 750 rpm, less than or equal to about 500 rpm, less than or equal to about 200 rpm, less than or equal to about 100 rpm, less than or equal to about 90 rpm, or less than or equal to about 75 rpm. Combinations of the above-referenced ranges are possible (e.g., greater than or equal to about 200 rpm and less than or equal to about 1000 rpm). Other ranges are also possible.

Following adsorption of the organic contaminants onto the adsorbent particles, the adsorbent particles may be removed from the sample, thereby forming a cleaned sample. Methods for forming a cleaned sample may comprise one or more of the following steps: filtering the sample, centrifuging the sample and preserving at least one of the supernatant and the precipitate, decanting the sample, straining the sample, and skimming the adsorbent particles from the sample surface. In some embodiments, removal of the adsorbent particles may be aided by the use of particles that float out the surface of the liquid. The amount of adsorbent particles removed may be greater than or equal to about 50%, greater than or equal to about 75%, greater than or equal to about 80%, greater than or equal to about 85%, greater than or equal to about 90%, greater than or equal to about 95%, greater than or equal to about 96%, greater than or equal to about 97%, greater than or equal to about 98%, greater than or equal to about 99%, greater than or equal to about 99.5%, or essentially all of the adsorbent particles.

According to certain embodiments, the contaminants which are removed from the contaminated sample may be reused by serving as a component of one or more commercial products. In some embodiments, the organic contaminants may be removed from the adsorbent particles and then incorporated into a petroleum product. In certain embodiments, the adsorbent particles comprising the fuel may be melted down and the resultant liquid may be incorporated into a petroleum product. Non-limiting examples of suitable petroleum products include gasoline, fuels, lubricants, waxes, tar, and asphalt.

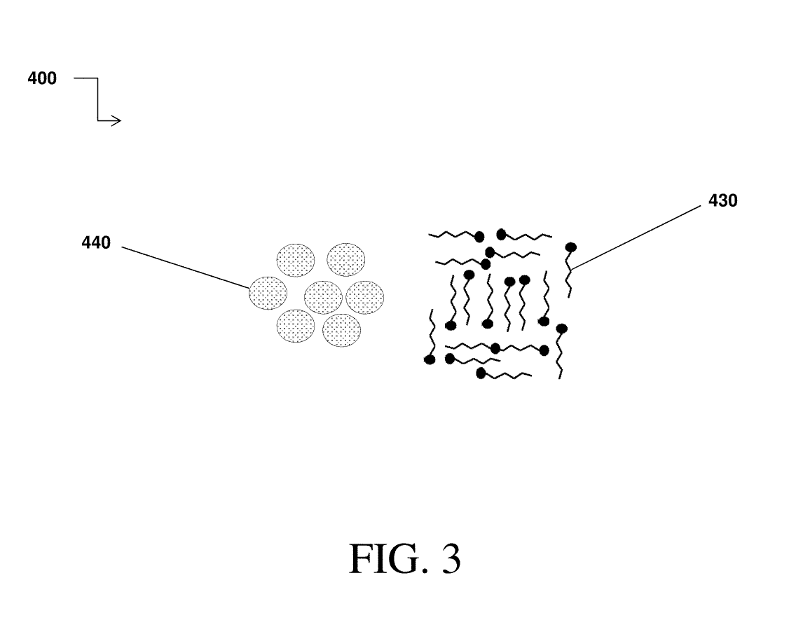

As noted above, in some embodiments, kits are provided. In some embodiments, the kit comprises a plurality of adsorbent particles and a surfactant. Adsorbent particles and surfactants are described in more detail herein. A non-limiting example of a kit is shown in FIG. 3. Kit 400 comprises surfactant 430 and adsorbent particles 440. In some embodiments, the kit may be used in methods for removing organic contaminants from a contaminated sample, for example, as described herein.

For the methods and kits described herein, the surfactant may be provided in a solution. For example, the surfactant may be provided as a solute in an aqueous solution. The solution may comprise any suitable amount of surfactant. In some embodiments, the aqueous solution may comprise greater than or equal to about 0.01 wt %, greater than or equal to about 0.025 wt %, greater than or equal to about 0.05 wt %, greater than or equal to about 0.1 wt % surfactant, greater than or equal to about 0.25 wt % surfactant, greater than or equal to about 0.5 wt % surfactant, greater than or equal to about 0.6 wt % surfactant, greater than or equal to about 0.75 wt % surfactant, greater than or equal to about 1 wt % surfactant, greater than or equal to about 1.5 wt % surfactant, greater than or equal to about 2 wt % surfactant, greater than or equal to about 2.5 wt % surfactant, greater than or equal to about 5 wt % surfactant, greater than or equal to about 7.5 wt % surfactant, greater than or equal to about 10 wt % surfactant, greater than or equal to about 20 wt % surfactant, greater than or equal to about 30 wt % surfactant, greater than or equal to about 50 wt % surfactant, based on the total weight of the solution comprising the surfactant. According to certain embodiments, the aqueous solution may comprise less than or equal to about 50 wt % surfactant, less than or equal to about 30 wt % surfactant, less than or equal to about 20 wt % surfactant, less than or equal to about 15 wt % surfactant, less than or equal to about 10 wt % surfactant, less than or equal to about 7.5 wt % surfactant, less than or equal to about 5 wt % surfactant, less than or equal to about 2.5 wt % surfactant, less than or equal to about 2 wt % surfactant, less than or equal to about 1.5 wt % surfactant, less than or equal to about 1 wt % surfactant, less than or equal to about 0.75 wt % surfactant, less than or equal to about 0.6 wt % surfactant, less than or equal to about 0.5 wt % surfactant, less than or equal to about 0.25 wt % surfactant, less than or equal to about 0.1 wt % surfactant, less than or equal to about 0.05 wt % surfactant, less than or equal to about 0.025 wt % surfactant, or less than or equal to about 0.01 wt % surfactant. Combinations of the above-referenced ranges are possible (e.g., greater than or equal to about 0.1 wt % surfactant and less than or equal to about 2 wt % surfactant, greater than or equal to about 0.1 wt % surfactant and less than or equal to about 10 wt % surfactant, or greater than or equal to about 0.1 wt % surfactant and less than or equal to about 50 wt % surfactant). Other ranges are also possible. The surfactant may be a single surfactant or a combination of two or more surfactants.

In some embodiments, the surfactants may act as mobilizing agents which enhance the desorption of organic contaminants from a contaminated sample. Mobilization of organic contaminants may increase the rate of organic contaminant removal in comparison to solubilization of organic contaminants in certain embodiments. In certain embodiments, mobilization of organic contaminants may prevent organic contaminants from adhering to process equipment, or may substantially reduce the amount of organic contaminants that adhere to process equipment. In some embodiments, mobilization of organic contaminants may prevent organic contaminants from adhering to glass and/or metal, or may substantially reduce the amount of organic contaminants that adhere to glass, metal and/or other container materials. In some embodiments, an aqueous solution comprising one or more surfactants acting as mobilizing agents may comprise an amount of surfactant that is at or above the critical micelle concentration. In some embodiments, the kit may comprise a surfactant solution which comprises surfactant at a level above the critical micelle concentration such that micelles are formed. In certain other embodiments, the kit may comprise a surfactant solution which comprises a surfactant at a level below the critical micelle concentration such that micelles are not formed. Without wishing to be bound by theory, solutions comprising larger amounts of surfactant may favor mobilization over solubilization to a higher degree than solutions comprising smaller amounts of surfactant. In certain embodiments, a surfactant acting as a mobilizing agent may extract each organic contaminant present with an equal or substantially equal efficiency. Such a surfactant may mobilize organic contaminants without solubilizing them in some embodiments. In certain other embodiments, the surfactant or surfactants may both mobilize organic contaminants and solubilize organic contaminants.

In some embodiments, a surfactant may be a biosurfactant. The biosurfactant may also be referred to herein as a biopolymer. According to certain embodiments, biosurfactants may be water soluble, biodegradable, highly digestible and/or non-toxic to aquatic organisms. In certain embodiments, one or more surfactants may comprise materials derived from plants, bacteria, and/or fungi such as proteins, polypeptides and/or fats. Suitable plants from which surfactants may be derived include grains, corn, corn gluten meal, and/or hemp in some embodiments.

In some embodiments, the surfactant may be commercially purchased. Non-limiting examples of commercially available surfactants include CT1 (GreenStract), Calfax® (Pilot Chemical Company) and, Brij™ 30 (Acros Organics).

According to certain embodiments, a surfactant comprises or may be a small molecule surfactant. In some embodiments, small molecule surfactants may be water soluble non-pollutants and may have one or more of the following properties: commercially available, capable of undergoing biodegradation, capable of undergoing digestion, and/or non-toxic to aquatic organism. Suitable small molecule surfactants may comprise one or more of anionic, cationic, zwitterionic, or nonionic surfactants. In some embodiments, small molecule surfactants may comprise any suitable charged group such as a sulfate group, a sulfonate group, a phosphate group, a carboxylate group, a protonated amine group or a permanently charged quaternary ammonium group. According to some embodiments, small molecule surfactants may comprise betaine groups. In certain embodiments, a small molecule surfactant may comprise a polar group such as an alcohol group or a polyethylene glycol group. In some embodiments, suitable small molecule surfactants may further comprise a nonpolar and uncharged group such as an alkyl group. Non-limiting examples of suitable surfactants include sodium 1,4-dihexyl sulfosuccinate, sodium diphenyl oxide disulfonate, polyoxyethylene lauryl ether, polyoxyethylene oleyl ether, polyoxyethylene stearyl ether, polyoxyethylene cetyl ether, Aerosol MA-80 surfactant, Calfax® surfactant, and/or Brij™ surfactants.

In some embodiments, the surfactant comprises one or more of an anionic surfactant, a cationic surfactant, a zwitterionic surfactant, or an uncharged surfactant. In some embodiments, the surfactant comprises one or more of a sulfate group, a sulfonate group, a phosphate group, a carboxylate group, a protonated amine group or a permanently charged quaternary ammonium group. In some embodiments, the surfactant comprises one or more of an alcohol group or a polyethylene glycol group. In some embodiments, the surfactant comprises one or more of 1,4-dihexyl sulfosuccinate, sodium diphenyl oxide disulfonate, polyoxyethylene lauryl ether, polyoxyethylene oleyl ether, polyoxyethylene stearyl ether, and polyoxyethylene cetyl ether.

In some embodiments, the surfactant is provided as a solution. In some embodiments, the surfactant is provided as an aqueous solution. In some embodiments, the aqueous solution further comprises and alkyl halide salt. In some embodiments, an aqueous solution comprising a surfactant may further comprise a salt or other additives. Non-limiting examples of suitable salts include halide salts. In some embodiments, an aqueous solution comprising a surfactant may further comprise sodium chloride.

The methods and kits described herein may utilize a surfactant and adsorbent particles in any suitable ratio. In some embodiments, the ratio of the mass of the adsorbent particles in grams to the volume of the aqueous solution comprising the surfactant in milliliters greater than or equal to about 0.0025, greater than or equal to about 0.005, greater than or equal to about 0.0075, greater than or equal to about 0.01, greater than or equal to about 0.015, greater than or equal to about 0.02, greater than or equal to about 0.022, greater than or equal to about 0.025, greater than or equal to about 0.03, greater than or equal to about 0.035, greater than or equal to about 0.04, greater than or equal to about 0.043, greater than or equal to about 0.045, greater than or equal to about 0.05, greater than or equal to about 0.055, greater than or equal to about 0.06, greater than or equal to about 0.065, greater than or equal to about 0.07, greater than or equal to about 0.08, or greater than or equal to about 0.1. According to certain embodiments, the ratio of the mass of the adsorbent particles in grams to the volume of the aqueous solution comprising the surfactant in milliliters is less than or equal to about 0.15, less than or equal to about 0.1, less than or equal to about 0.08, less than or equal to about 0.07, less than or equal to about 0.065, less than or equal to about 0.06, less than or equal to about 0.055, less than or equal to about 0.05, less than or equal to about 0.045, less than or equal to about 0.043, less than or equal to about 0.04, less than or equal to about 0.035, less than or equal to about 0.03, less than or equal to about 0.025, less than or equal to about 0.022, less than or equal to about 0.02, less than or equal to about 0.015, less than or equal to about 0.01, less than or equal to about 0.0075, less than or equal to about 0.005, or less than or equal to about 0.0025. Combinations of the above-referenced ranges are possible (e.g., greater than or equal to about 0 and less than or equal to about 0.065). Other ranges are also possible. It should also be understood that the optimal and acceptable ranges may be different depending on the type of adsorbent particle. In some embodiments, the adsorbent particles are sytrofoam particles.

The ratio of mass of the adsorbent particles in milligrams to the mass of the contaminated sample in grams (e.g., contaminated soil) for the methods and kits described herein may be any suitable value. In some embodiments, the ratio is greater than or equal to about 1, greater than or equal to about 2, greater than or equal to about 2.2, greater than or equal to about 4.3, greater than or equal to about 7.5, greater than or equal to about 10, greater than or equal to about 15, greater than or equal to about 20, greater than or equal to about 22, greater than or equal to about 25, greater than or equal to about 30, greater than or equal to about 33, greater than or equal to about 35, greater than or equal to about 40, greater than or equal to about 43, greater than or equal to about 45, greater than or equal to about 50, greater than or equal to about 55, greater than or equal to about 60, greater than or equal to about 65, greater than or equal to about 70, greater than or equal to about 80, or greater than or equal to about 100. According to certain embodiments, the kit may comprise a surfactant and adsorbent particles in amounts such that the ratio of the mass of the adsorbent particles in grams to the volume of the aqueous solution comprising the surfactant in milliliters is less than or equal to about 150, less than or equal to about 100, less than or equal to about 80, less than or equal to about 70, less than or equal to about 65, less than or equal to about 60, less than or equal to about 55, less than or equal to about 50, less than or equal to about 45, less than or equal to about 43, less than or equal to about 40, less than or equal to about 35, less than or equal to about 33, less than or equal to about 30, less than or equal to about 25, less than or equal to about 22, less than or equal to about 20, less than or equal to about 15, less than or equal to about 10, less than or equal to about 7.5, less than or equal to about 4.3, less than or equal to about 2.2, less than or equal to about 2, or less than or equal to about 1. Combinations of the above-referenced ranges are possible (e.g., greater than or equal to about 2 and less than or equal to about 100 or greater than or equal to about 2.2 and less than or equal to about 65). Other ranges are also possible. It should also be understood that the optimal and acceptable ranges may be different for different adsorbent particle and surfactant combinations. In some embodiments, the adsorbent particles are sytrofoam particles and the surfactant is a biosurfactant.

The ratio of the volume of the aqueous solution comprising the surfactant in milliliters to the mass of the contaminated sample (e.g., contaminated soil) in grams for the methods and kits described herein may be any suitable value. In some embodiments, the ratio is greater than or equal to about 0.05, greater than or equal to about 0.1, greater than or equal to about 0.2, greater than or equal to about 0.25, greater than or equal to about 0.5, greater than or equal to about 0.75, greater than or equal to about 1, greater than or equal to about 1.25, greater than or equal to about 1.5, greater than or equal to about 1.75, greater than or equal to about 2, greater than or equal to about 3, greater than or equal to about 5, greater than or equal to about 7.5, greater than or equal to about 10, greater than or equal to about 12.5, greater than or equal to about 15, greater than or equal to about 17.5, or greater than or equal to about 20. In certain embodiments, the kit may be added to a contaminated sample in an amount such that the ratio of the volume of the aqueous solution comprising the surfactant in milliliters to the mass of the contaminated sample in grams is less than or equal to about 25, less than or equal to about 20, less than or equal to about 17.5, less than or equal to about 15, less than or equal to about 12.5, less than or equal to about 10, less than or equal to about 7.5, less than or equal to about 5, less than or equal to about 3, less than or equal to about 2, less than or equal to about 1.75, less than or equal to about 1.5, less than or equal to about 1.25, less than or equal to about 1, less than or equal to about 0.75, less than or equal to about 0.5, less than or equal to about 0.25, less than or equal to about 0.2, less than or equal to about 0.1, or less than or equal to about 0.05. Combinations of the above-referenced ranges are possible (e.g., greater than or equal to about 0.1 and less than or equal to about 20, greater than or equal to about 0.25 and less than or equal to about 2 or greater than or equal to about 1 and less than or equal to about 3). Other ranges are also possible. It should also be understood that the optimal and acceptable ranges may be different for different surfactants. In some embodiments, the surfactant is a biosurfactant.

The methods and kits described herein comprise adsorbent particles. In some embodiments, the adsorbent particles are not water soluble. In certain embodiments, the adsorbent particles are recyclable and/or comprise recycled material. In some embodiments, the adsorbent particles are commercially available.

In some embodiments, the adsorbent particles are adsorbent polymer particles and are formed of a polymeric material. Non-limiting examples of polymeric materials include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ε-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the adsorbent polymer particles may comprise one or more of polystyrene, Styrofoam, Rexolite, polyethylene (e.g., high density, low density, expanded, etc.), and/or polypropylene (e.g., high density, low density, expanded, etc.).

According to some embodiments, the adsorbent particles may have a microstructure which is substantially amorphous. In some embodiments, substantially amorphous microstructures are microstructures wherein the mass of the polymer comprises less than or equal to about 30%, less than or equal to about 25%, less than or equal to about 20%, less than or equal to about 15%, less than or equal to about 10%, less than or equal to about 5%, less than or equal to about 2.5%, or less than or equal to about 1%, crystalline material. The crystallinity of a polymer may be determined by any suitable method, many of which are known to those skilled in the art. One non-limiting example of a method for determining percent crystallinity is differential scanning calorimetry (DSC).

In certain embodiments, the adsorbent particles may be at least partially crosslinked. For example, in some embodiments the adsorbent particles may comprise at least 1 wt %, 5 wt %, at least 10 wt %, at least 25 wt %, at least 50 wt %, at least 75 wt %, at least 90 wt %, at least 95 wt %, at least 99 wt %, or identically 100 wt % cross-linked polymer. In certain embodiments, the adsorbent particles may comprise less than 100 wt %, less than 99 wt %, less than 95 wt %, less than 90 wt %, less than 75 wt %, less than 50 wt %, less than 25 wt %, less than 10 wt %, less than 5 wt %, less than 1 wt %, or identically 0 wt % crosslinked polymer. Combinations of the above-referenced ranges are possible (e.g., greater than 10 wt % and less than 25 wt % crosslinked polymer). Other ranges are also possible.

In some embodiments, the adsorbent particles may be porous. The pores may be any suitable size. In some embodiments, the size of the pores may be quantified by their greatest cross-sectional diameter, which is the longest straight line that can be drawn through the particle from one point on its surface to a different point on its surface. In accordance with certain embodiments, the average greatest cross-sectional diameter of the pores may be greater than or equal to about 0.1 micron, greater than or equal to about 1 micron, greater than or equal to about 5 microns, greater than or equal to about 10 microns, greater than or equal to about 25 microns, greater than or equal to about 50 microns, or greater than or equal to about 75 microns. In some embodiments, the average greatest cross-sectional diameter of the pores may be less than or equal to about 100 microns, less than or equal to about 75 microns, less than or equal to about 50 microns, less than or equal to about 25 microns, less than or equal to about 10 microns, less than or equal to about 5 microns, or less than or equal to about 1 micron. Combinations of the above-referenced ranges are possible (e.g., greater than or equal to about 10 microns and less than or equal to about 50 microns). Other ranges are also possible.

According to certain embodiments, the adsorbent polymer particles may be extruded. The adsorbent polymer particles may be in the form of a foam in some embodiments. The foam may be expanded or condensed and may be high or low density.

In some embodiments, the adsorbent particles may have a density such that they are capable of floating on the surface of the contaminated samples and/or liquids comprising contaminated samples. In certain embodiments, the adsorbent particles may have a density such that they float on water or aqueous solutions. According to certain embodiments, the density of the adsorbent particles may be less than or equal to about 1000 kg/m³, less than or equal to about 750 kg/m³, less than or equal to about 500 kg/m³, less than or equal to about 250 kg/m³, less than or equal to about 100 kg/m³, less than or equal to about 75 kg/m³, less than or equal to about 50 kg/m³, less than or equal to about 25 kg/m³, less than or equal to about 20 kg/m³, less than or equal to about 15 kg/m³, less than or equal to about 10 kg/m³, or less than or equal to about 5 kg/m³. In some embodiments, the density of the adsorbent particles may be greater than or equal to about 2.5 kg/m³, greater than or equal to about 5 kg/m³, greater than or equal to about 10 kg/m³, greater than or equal to about 15 kg/m³, greater than or equal to about 20 kg/m³, greater than or equal to about 25 kg/m³, greater than or equal to about 50 kg/m³, greater than or equal to about 75 kg/m³, greater than or equal to about 100 kg/m³, greater than or equal to about 250 kg/m³, greater than or equal to about 500 kg/m³, or greater than or equal to about 750 kg/m³. Combinations of the above-referenced ranges are possible (e.g., greater than or equal to about 15 kg/m³ and less than or equal to about 25 kg/m³). Other ranges are also possible. It should also be understood that the optimal and acceptable ranges may be different depending on the type of adsorbent particle. In some embodiments, the adsorbent particles are Styrofoam particles.

The adsorbent particles may have any suitable size. In some embodiments, the size of the adsorbent particles may be quantified by their greatest cross-sectional diameter. According to some embodiments, the average greatest cross-sectional diameter is the average of the cross-sectional diameters of the particles comprising the kit. In certain embodiments, the adsorbent particles may have an average greatest cross-sectional diameter greater than or equal to about 1 mm, greater than or equal to about 2 mm, greater than or equal to about 3 mm, greater than or equal to about 5 mm, greater than or equal to about 7 mm, greater than or equal to about 9 mm, greater than or equal to about 10 mm, greater than or equal to about 12.5 mm, greater than or equal to about 15 mm, or greater than or equal to about 17.5 mm. According to some embodiments, the adsorbent particles may have an average greatest cross-sectional diameter of less than or equal to about 20 mm, less than or equal to about 17.5 mm, less than or equal to about 15 mm, less than or equal to about 12.5 mm, less than or equal to about 10 mm, less than or equal to about 9 mm, less than or equal to about 7 mm, less than or equal to about 5 mm, less than or equal to about 3 mm, or less than or equal to about 1 mm. Combinations of the above-referenced ranges are possible (e.g., greater than or equal to about 3 mm and less than or equal to about 10 mm). Other ranges are also possible. It should also be understood that the optimal and acceptable ranges may be different depending on the type of adsorbent particle. In some embodiments, the adsorbent particles are Styrofoam particles.

In certain embodiments, adsorbent particles comprising larger surface areas may be more efficient at organic contaminant adsorption than adsorbent particles comprising smaller surface areas. Accordingly, adsorbent particles comprising small pores, high pore volume fractions, and/or high pore tortuosity may be utilized in some embodiments.

In some embodiments, the adsorbent particles may be replenished during organic contaminant removal. In some embodiments, the adsorbent particles may be replenished during the agitation step. Adsorbent particle replenishment may comprise removing adsorbent particles to which organic contaminants have adsorbed from a mixture comprising a contaminated sample, a surfactant, and adsorbent particles in some embodiments, followed by addition of another set of adsorbent particles. The particles may be replaced one, two, three, or more times. In certain embodiments, adsorbent particles which do not comprise organic contaminants may then be added to this mixture and the mixture may then be agitated. In some embodiments, addition of additional adsorbent particles may advantageously result in an increase in the efficiency of organic contaminant removal while not requiring an increase in the total agitation time.

In some embodiments, kits and/or methods described herein may be used to remove organic contaminants from a contaminated sample. Non-limiting examples of contaminated samples from which organic contaminants may be removed include contaminated water, contaminated soil, and contaminated sediment. Contaminated water may comprise fresh water and/or salt water, and may be comprise one or more of a bay, bayou, bight, brook, canal, channel, creek, delta, estuary, gulf, headland, harbor, inlet, lagoon, lake, marsh, ocean, pond, reservoir, river, sea, sound, spring, strait, stream, or swamp. In some embodiments, contaminated soils and/or contaminated sediments may comprise materials that are located within a body of water.

The adsorbent particles comprising the adsorbed organic contaminants may be treated and/or otherwise disposed of following removal from the cleaned sample. In some embodiments, the organic contaminants are removed or at least partially removed from the adsorbent particles and utilized for other purposes (e.g., for fuel). In some embodiments, the adsorbent particles, with or without the organic contaminants, may be processed (e.g., heated) to reduce the volume of the particles. For example, a polystyrene foam may be heated, thus reducing the volume of the particles.

According to certain embodiments, organic contaminants may comprise one or more of coal tar, crude oil, creosote, refined and unrefined oil and by-products, resins, aliphatic molecules, and polycyclic aromatic hydrocarbons (PAHs), or total petroleum hydrocarbons (TPHs). PAHs may comprise any number of rings, such as 2 rings, 3 rings, 4 rings, 5 rings, and/or 6 rings. Non-limiting examples of PAHs include naphthalene, acenaphthylene, acenaphthene, fluorine, phenanthrene, anthracene, fluoranthene, pyrene, benz[a]anthracene, chrysene, benzo[b]fluoranthrene, benzo[k]fluoranthrene, benzo[a]pyrene, indeno[1.2.3.-cd]pyrene, dibenz[ah]anthracene, benzo[ghi]perylene, as well as nitrogen, sulfur heterocyclic aromatic compounds, their alkylated homologs, and asphaltenes.

According to certain embodiments, organic contaminants may be present in multiple fractions, including, but not limited to, sand, silt, and clay, or combinations thereof.

The following examples are intended to illustrate certain embodiments of the present invention, but do not exemplify the full scope of the invention.

### Example 1

This example describes a sustainable, green chemistry method for the treatment of coal tar impacted sediment according to some embodiment. A mixture of proteins, polypeptides extracted from hemp is mixed with polystyrene foam and sediment. The biosurfactant liberates tar in minutes, which sorbs onto polystyrene. Since the sorbent floats, coal tar is easily removed from the agitation vessel. A 4-dimensional surface response model accurately predicts removal rates of coal tar and operational costs. At optimum conditions, the system removed 81% of polycyclic aromatic hydrocarbons (PAH) and 73% of the total hydrocarbon mass in the sediment. Scanning electron microscope images illustrate pure tar adsorption onto the foam. Onsite treatment of 25 kg sediment was in excellent agreement with lab (10 g) experiments and model predictions. The process is sustainable and green because the active ingredients are derived from a renewable crop material, recycled polystyrene is used in the process, and the biosurfactant can be reused to conserve water and to reduce water treatment costs.

This example reports the results of a high-throughput, hemp-based biosurfactant/polystyrene foam reactor system. The biosurfactant, CT1, is a complex mixture of proteins, polypeptides and fat. When CT1 is used with polystyrene, coal tar rapidly releases in minutes then adsorbs onto polystyrene due to strong pi-pi interactions between aromatics in the tar and the polymer. Surprisingly, mass balance experiments indicate removal rates for bulk tar were the same as that of aromatics. Polystyrene foam is an appealing engineering solution for heavy oils and tars because it floats in water and is easily recovered from the agitation vessel along with sorbed hydrocarbons. It is also an attractive alternative to other solid polymer adsorbents since recycled material can be used. Toward this end, a response surface model was developed to optimize the biosurfactant/polymer system. The reactor yielded >80% coal tar recovery from highly aged river sediment.

Coal tar contaminated sediment was obtained from the Grand Calumet River. The manufactured gas plant operated on the banks of the river from 1901 to 1950. High concentrations of pure-phase tar persist in the sediment to this day. The river bottom was collected by back hoe and put into a 10 m³ rolloff for testing. The biosurfactant, CT1, was obtained from GreenStract, LLP (New York, N.Y.). Polystyrene insulation panels (density=20 kg/m³) were purchased from a local hardware store and ground to make polystyrene foam pellets (PFP, 3-10 mm in diameter).

Analytical grade dichloromethane and toluene were purchased from VWR™ (Radnor, 107 PA). Calibration mix #5 (the 16 EPA priority pollutant PAH), internal standard mix (acenaphthene-d10, chrysene-d12, 1,4-dichlorobenzene-d4, naphthalene-d8, perylene-d12, and phenanthrene-d10), surrogate mix SOM01.1 (2-methylnaphthalene-d12, and fluoranthene-d12), and copper granules were obtained from Restek (Bellafonte, Pa.). Polypropylene syringes, 12 mL, and fiber glass filter tips, 1 uM, were obtained from MicroLiter Analytical Supplies, Inc. (Suwanee, Ga.) and Tisch (Cleves, Ohio), respectively. Whatman #1 filter paper 90 mm was purchased from GE Healthcare (Pittsburgh, Pa.). Hydromatrix drying agent was purchased from Agilent Technologies (Santa Clara, Calif.).

To model the biosurfactant-enhanced polymer partition process, 10 g of sediment was sealed in 4 oz glass jars with known amounts of CT1 and PFP, for details see Table 1. Duct tape was applied to the outer surface of each jar to increase friction. The sample was agitated at 90 rpm using a fixed speed dual drum rotary rock tumbler from Harbor Freight Tools (Calabasas, Calif.). After mixing, the supernatant was skimmed to collect 119 PFP using a 16 mesh screen. After collection, PFP was gently sprayed with water to wash soil particles from the surface. After the solids settled, CT1 and wash water were decanted from the “cake” that formed at the bottom of the jar. Before gas chromatography/mass spectrometry (GC/MS) and total organic carbon (TOC) analysis, ˜1 g of cake was dried in an oven overnight at 90° C. to determine the dry weight of the sediment.

TABLE 1
Experimental conditions and results of PAH extracted from coal tar impacted sediment.
Model-coded values between −1 (minimum) and 1 (maximum) in parenthesis.

| Experiment | Mᵥₒₗᵤₘₑ:Sₘₐₛₛ, | | CT1 | | PFPₘₐₛₛ:Sₘₐₛₛ, | | Mixing | | % |
|---|---|---|---|---|---|---|---|---|---|
| No. | mL/g | | concentration, % | | g/g | | time, hr | | Removal |
| 1 | 1 | (−1) | 2 | (1) | 0.065 | (1) | 0.5 | (−1) | 37.7 |
| 2 | 1 | (−1) | 2 | (1) | 0.065 | (1) | 1 | (−0.33) | 46.2 |
| 3a | 1 | (−1) | 2 | (1) | 0.065 | (1) | 2 | (1) | 50.7 |
| 3b | 1 | (−1) | 2 | (1) | 0.065 | (1) | 2 | (1) | 50.8 |
| 4 | 2 | (0) | 1 | (0) | 0.065 | (1) | 2 | (1) | 67.1 |
| 5 | 1 | (−1) | 0.1 | (−9) | 0.065 | (1) | 2 | (1) | 39.7 |
| 6 | 1 | (−1) | 0.5 | (−0.5) | 0.065 | (1) | 2 | (1) | 50.5 |
| 7 | 1 | (−1) | 0 | (−1) | 0.065 | (1) | 2 | (1) | 14.9 |
| 8 | 1 | (−1) | 2 | (1) | 2.2 * 10⁻³ | (−0.93) | 2 | (1) | 41.9 |
| 9 | 1 | (−1) | 2 | (1) | 4.3 * 10⁻³ | (−0.87) | 2 | (1) | 48.2 |
| 10 | 1 | (−1) | 2 | (1) | 0.22 | (−0.33) | 2 | (1) | 16.4 |
| 11 | 1 | (−1) | 2 | (1) | 0 | (−1) | 2 | (1) | 48.2 |
| 12 | 1 | (−1) | 1 | (0) | 0.043 | (0.33) | 1 | (−0.33) | 27.4 |
| 13 | 1 | (−1) | 0.5 | (−0.5) | 0.043 | (0.33) | 0.5 | (−1) | 40.0 |
| 14 | 2 | (0) | 0.5 | (−0.5) | 0.065 | (1) | 2 | (1) | 70.3 |
| 15a | 2 | (0) | 0.5 | (−0.5) | 0.065 | (1) | 2 | (2) | 83.2 |
| 15b | 2 | (0) | 0.5 | (−0.5) | 0.065 | (1) | 2 | (2) | 83.6 |
| 16c | 2 | (0) | 0.5 | (−0.5) | 0.065 | (1) | 2 | (2) | 80.4 |
| 16 | 2 | (0) | 2 | (1) | 0.022 | (−0.33) | 1 | (−0.33) | 51.4 |
| 17 | 1 | (−1) | 0 | (−1) | 0 | (−1) | 0.5 | (−1) | 20.3 |
| 18 | 1 | (−1) | 2 | (1) | 0 | (−1) | 0.5 | (−1) | 21.9 |
| 19 | 2 | (0) | 0 | (−1) | 0.065 | (1) | 0.5 | (−1) | 54.3 |
| 20 | 2 | (0) | 0 | (−1) | 0 | (−1) | 2 | (1) | 5.6 |
| 21 | 3 | (1) | 0 | (−1) | 0.033 | (0) | 2 | (1) | 64.6 |
| 22 | 2 | (0) | 2 | (1) | 0 | (−1) | 2 | (1) | 34.5 |
| 24a | 3 | (1) | 2 | (2) | 0.065 | (1) | 0.5 | (−1) | 61.5 |
| 24b | 3 | (1) | 2 | (2) | 0.065 | (1) | 0.5 | (−1) | 60.9 |
| 24c | 3 | (1) | 2 | (2) | 0.065 | (1) | 0.5 | (−1) | 62.6 |
| 25 | 3 | (1) | 0 | (−1) | 0.065 | (1) | 1.5 | (0.33) | 75.8 |
| 26a | 3 | (1) | 2 | (1) | 0.065 | (1) | 2 | (1) | 79.6 |
| 26b | 3 | (1) | 2 | (1) | 0.065 | (1) | 2 | (1) | 81.0 |
| 26c | 3 | (1) | 2 | (1) | 0.065 | (1) | 2 | (1) | 81.3 |
| 27 | 2 | (0) | 2 | (1) | 0.130 | | 2 | (1) | 91.2 |
| 28 | 1 | (−1) | 2 | (1) | 0.065 | (1) | 10 | | 54.0 |
| 29 | 2.5 | (0.5) | 2 | (1) | 0.065 | (1) | 2 | (1) | 94.2 |

To determine extraction efficiency by GC/MS, an automated pressurized liquid extraction and solvent evaporation system from Fluid Management Systems (Watertown, Mass.) was used to extract the samples. 20 uL of 2000 ug/mL surrogate solution in dichloromethane were injected onto 2 g sediment. The sediment was mixed with 2 g Hydromatrix and added to a 40 mL extraction cell; the remaining dead volume of the cell was filled with Hydromatrix. The system was programmed to deliver solvent to the extraction cell at 20 mL/min for 2.4 min and then pressurize to 1500 psi over 2.5 min. The pressurized cell was heated to 120° C. in 5 min. The temperature and pressure were held constant for 20 min before the cell was allowed to cool to room temperature over a 20 min period, and then depressurized. Solvent was flushed through the cell at 20 mL/min for 1.3 min before N₂ gas purged the residual solvent. Extracts were delivered to the evaporation unit and concentrated to ˜2 mL in the presence of 2 g copper granules to remove elemental sulfur. The evaporation unit was programmed to heat to 65° C. and provide a 12 PSI N₂ purge. The concentrated extracts were passed through a polypropylene syringe fitted with 1 uM fiber glass filters along with solvent washes to remove any remaining fines. The final extract volume was approximately 3-4 mL. These extracts were weighed and analyzed.

Mass balance experiments were performed to assess total solvent extractable materials (TSEM). Three samples each of untreated and treated sediment (see experiment 32 in Table 1) were dried and then ground to a fine powder in a mortar and pestle. All samples, 4 g each, were extracted 5-times for 10 min with 10 mL of a 1:1 toluene/dichloromethane mixture using a Branson 5200 Ultrasonic Cleaner (Danbury, Conn.). The extracts were filtered, concentrated under a gentle stream of nitrogen, and then baked overnight at 90° C. to evaporate residual solvent, with the remaining tar mass weighed.

To evaluate extraction efficiency in the field, a 0.25 m³ cement mixer, operating at 90 rpm, was used to agitate CT1, sediment, and PFP in the field. A total of 25 kg (5 gallons) of river sediment was used in each experiment. Field experiment 21 (Table 1) was replicated to assess operational scalability. A 2% CT1 solution was added to the cement mixer at a mobile phase volume (Mᵥₒₗᵤₘₑ) to sediment mass (Sₘₐₛₛ) ratio of 2:1. PFP was added at a ratio of 0.022:1 g/g (PFPₘₐₛₛ:Sₘₐₛₛ) to the sediment and mixed for 1 hr. After agitation, PFP floated to the top of the mixer and removed via slotted shovel. The suspended fines were collected in 16 oz. jars, sealed, and shipped to Tufts for analysis. The settled particles formed a “cake” overnight. After decanting the supernatant, PAH analysis was performed on the remaining solids as previously described.

A Vario MICRO cube analyzer from Elementar™ (Hanau, Germany) was used to measure TOC in the sediment. A Shimadzu (Baltimore, Md.) model QP2010+GC/MS was used to analyze the samples. Helium gas served as the carrier gas at 100 kPa head pressure. 1 uL sample injections were made. The high temperature fused silica Rxi-5MS column (30 m×0.25 mm×0.25 um) was obtained from Restek®. The GC was temperature programmed as follows: 60° C. for 1 min, 6.5° C./min to 320° C., hold for 5 min. The inlet, interface, and ion source were maintained at 320° C., 280° C., and 230° C., respectively. The MS was operated in full-scan mode from m/z 50-350. Ion Analytics© software (Andover, Mass.) was used to analyze the data.

Before and after extraction treatment, images of PFP were taken using a Phenom Pro desktop scanning electron microscope (SEM). Carbon tape was used to affix the sample to the holder. Dust was removed with Dust-Off® cleaner before loading samples into the instrument. All samples were imaged without sputter-coating in the charge-up reduction mode.

Four variables were tested for their effect on PAH extraction efficiency. These included Mᵥₒₗᵤₘₑ:Sₘₐₛₛ (X₁), CT1 concentration (X₂), PFPₘₐₛₛ:Sₘₐₛₛ (X₃), and mixing time (X₄). The model below provides information on both individual variables and their interactions.

Y=b₀+b₁X₁+b₂X₂+b₃X₃+b₄X₄+b₁₂X₁X₂+b₁₃X₁X₃+b₁₄X₁X₄+b₂₄X₂X₄+b₃₄X₃X₄+b₁₁X₁²+b₂₂X₂₂²+b₃₃X₃₃²+b₄₄X₄²

Experiments 1-16 was used to determine the min (−1) and max (1) values for each variable over the range: X₁=1-3 mL/g; X₂=0-2% active ingredient; X₃=0-0.065 g/g; and X₄=0.5-2.0 hr. Given these initial experiments, the D-Optimal experimental design approach was used to find the subset of experiments that leads to the highest determinant of the information matrix, which corresponds to the smallest variance of the coefficients in the model. In order to compare subsets with different numbers of experiments, the normalized determinant M=det/n^{p} was taken into account, where n is the number of experiments and p is the number of parameters to be estimated. When the number of experiments increases, both the numerator (quality of information) and the denominator (experimental effort) increase. The normalized determinant weights the quality of the information, expressed as the variance of the coefficients in the model, by the experimental effort. From this, nine additional experiments were carried out. These experiments are listed in Table 1 as 17 to 25. Experiments 15, 24 and 26 were repeated three-times each and experiment 3 was repeated twice to determine model variability. Experiment 26 was performed at the maximum condition for each of the four variables, while experiment 3 was repeated to investigate systematic effects due to differences in time between when experiments 1-16 and 17-26 were performed. As a result, the model consists of 33 experiments under conditions 1-26 (16 initial, 9 D-Optimal, and replicates).

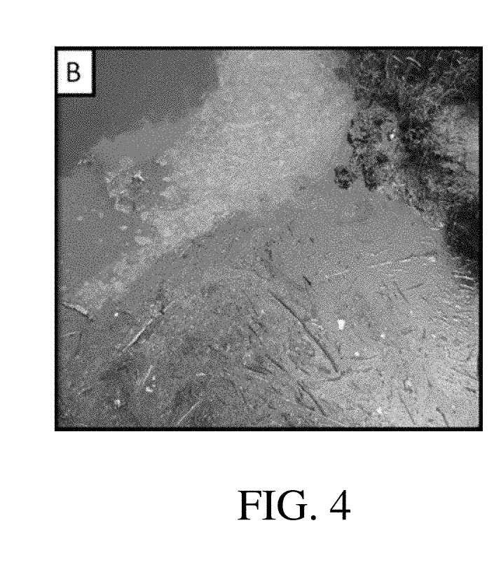

Coal tar, the primary pollutant at MGP sites, is a dense nonaqueous phase liquid (DNAPL). It consists of thousands of chemicals that can migrate long distances from their release point. Polycyclic aromatic hydrocarbons (PAH) are critically important regulatory benchmarks when classifying and cleaning hazardous waste sites because of their carcinogenicity, mutagenicity, teratogenicity, and toxicity. Although PAH attract most of the attention from environmentalists so too should tar mass. Since coal tar is heavier than water, it sinks once liberated from solids. In this experiment, the amount of biosurfactant needed to liberate tar from sediment and the amount of solid polymer needed to sorb, float and remove the tar from solution were determined. A 4-dimensional surface response model based on 33 experiments and replicates was developed. Despite 70 years of weathering, coal tar is visible along the river banks and in the sediment at depths of up to 3 m. Also visible is a hydrocarbon film on the water surface, see FIG. 4. The sediment, a thick, black mud, was 30-35% solids, 60% water, and 5-10% tar by mass. 85% of the 209 solids were <250 um; the remainder <50 um. Total organic carbon was 16.4±0.3%, indicating high organic matter content in the sample. Table 2 shows both total PAH content in the initial sediment as well as total solvent extractable materials (TSEM), an indicator of bulk tar content. TSEM was found to be 6.6±1.3% by mass, while total PAH concentration in the river bottom was 6900 ug/g, comprising 10.5% of the extractable organics. Table 3 lists initial PAH concentrations, which were between 1600 ug/g for naphthalene and 30 ug/g for dibenz[a,h]anthracene.

TABLE 2
Comparison of total polycyclic aromatic hydrocarbon (PAH) and total
mass (TSEM) concentrations, ug/g, before and after treatment at
optimum model predicted conditions.

| | | Optimized | |
|---|---|---|---|
| Compound | Initial (n = 3) | Treatment (n = 3) | % Removal |
| Total PAH (GC/ | 6,900 +/− 164 | 1,284 +/− 58 | 81.4 |
| MS) | | | |
| Total Coal Tar | 65,800 +/− 12,500 | 17,800 +/− 2,200 | 73.0 |
| (TSEM) | | | |

TABLE 3
PAH concentrations before and after treatment at optimum model predicted conditions,
ug/g.

| | | Optimized | | % Removal by |
|---|---|---|---|---|
| Compound | Initial | Treatment | % Removal | Ring Number |
| Naphthalene | 1575 +/− 25 | 365 +/− 24 | 76.8 | — |
| Acenaphthylene | 78 +/− 4 | 11 +/− 1 | 11 +/− 1 | 3 ring: |
| Acenaphthene | 1,017 +/− 52 | 194 +/− 12 | 80.9 | 82.3 +/− 2.0 |
| Fluorene | 407 +/− 20 | 78 +/− 1 | 80.9 | |
| Phenanthrene | 1,342 +/− 52 | 236 +/− 6 | 82.4 | |
| Anthracene | 413 +/− 9 | 75 +/− 3 | 81.8 | |
| Fluoranthene | 385 +/− 15 | 66 +/− 5 | 82.9 | 4 ring: |
| Pyrene | 650 +/− 11 | 106 +/− 7 | 83.7 | 83.8 +/− 1.3 |
| Benz[a]anthracene | 266 +/− 4 | 38 +/− 3 | 85.6 | |
| Chrysene | 229 +/− 2 | 39 +/− 3 | 83.0 | |
| Benzo[b]fluoranthene | 81 +/− 7 | 11 +/− 1 | 86.2 | 5- and 6-ring: |
| Benzo[k]fluoranthene | 108 +/− 2 | 11 +/− 3 | 89.6 | 85.3 +/− 4.4 |
| Benzo[a]pyrene | 177 +/− 10 | 26 +/− 3 | 85.2 | |
| Indeno[1,2,3-cd]pyrene | 66 +/− 6 | 10 +/− 2 | 84.8 | |
| Dibenzh[ah]anthracene | 30 +/− 3 | 7 +/− 2 | 78.2 | |
| Benzo[ghi]perylene | 66 +/− 6 | 10 +/− 2 | 84.8 | |

Predictive tools can be useful for determining optimum process conditions and for obtaining estimates of time and material cost under desired conditions. For instance, if the goal is to process 300 m³ of sediment per day to remediate a 10000 m³ site, the statistical experimental design may find the optimum mobilizing phase-to-sediment (Mᵥₒₗᵤₘₑ:Sₘₐₛₛ) ratio, biosurfactant (CT1) concentration, polymer-to-sediment (PFPₘₐₛₛ:Sₘₐₛₛ) ratio, and mixing time to process the material, trading off cost versus recovery. Since the amount of water needed to treat the sediment is both a materials and water treatment cost, it is useful to know if water in the river bottom can be used to make a pumpable fluid and if the CT1 solution itself is reusable.

Table 1 lists the initial experiments used to define the minimum (−1) and maximum (+1) values for each variable and for the model itself, where X₁=Mᵥₒₗᵤₘₑ:Sₘₐₛₛ, X₂=CT1 concentration, X₃=PFPₘₐₛₛ:Sₘₐₛₛ, X₄=mixing time, and Y the PAH removal rate.

Y=45.5+6.2X₁(*)+5.4X₂(*)+18.9X₃(***)+4.9X₄(*)−6.5X₁X₂(*)+12.2X₁X₃(**)+4.9X₃X₄−11.3X₁²(*)

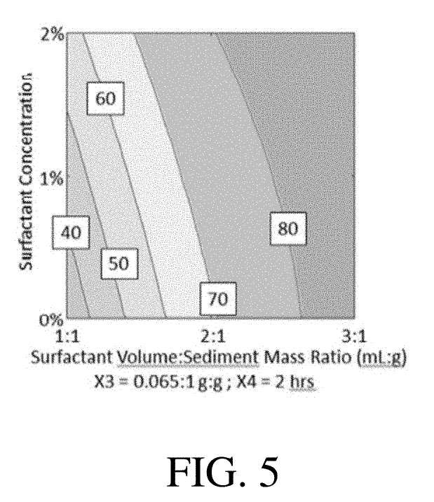

The following statistics were obtained: R²_{A}=0.79 (adjusted coefficient of determination), ZZ=10.3 (standard deviation of the residuals), ZZ=68.4% (explained variance in cross-validation), ZZ=12.8 (cross validation root mean square error), *=p<0.05, **=p<0.01, ***=p<0.001. The PFPₘₐₛₛ:Sₘₐₛₛ ratio is an impactful variable, since tar sorption is generally dependent on the amount of PFP. The fact that Mᵥₒₗᵤₘₑ:Sₘₐₛₛ is quadratic means too low or too high a ratio may result in inefficient recoveries. FIG. 5 shows the plot of CT1 concentration vs. Mᵥₒₗᵤₘₑ:Sₘₐₛₛ ratio, where PFPₘₐₛₛ:Sₘₐₛₛ and mixing time are optimized. Although the biosurfactant volume is important, the impact of concentration on extraction efficiency may be less significant than volume. As a consequence of the interaction between these two variables, a higher surfactant concentration generally improves removal efficiency when Mᵥₒₗᵤₘₑ is low. At high volume, surfactant concentration may have little measurable effect on tar removal. The plot also suggests a Mᵥₒₗᵤₘₑ:Sₘₐₛₛ ratio of at least 2:1 may be required for efficient (>75%) removal of PAH from sediment.

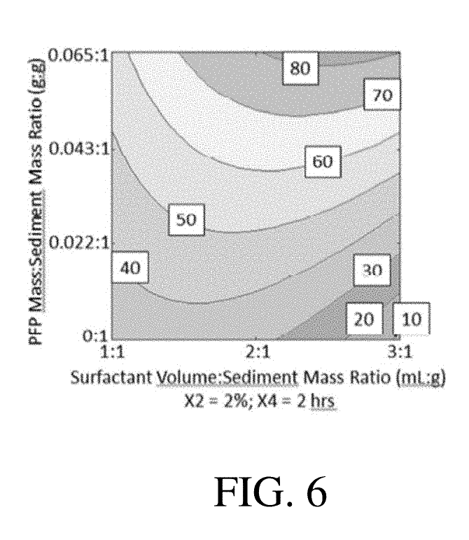

The X₁X₃ term describes how PFPₘₐₛₛ and Mᵥₒₗᵤₘₑ influences extraction efficiency as a function of sediment mass treated. Shown in FIG. 6 is the Mᵥₒₗᵤₘₑ:Sₘₐₛₛ vs. PFPₘₐₛₛ:Sₘₐₛₛ plot, where the concentration of CT1 and mixing time are constant. Improvement in PAH removal may be linked to PFPₘₐₛₛ. Optimum extraction may occur when Mᵥₒₗᵤₘₑ and PFPₘₐₛₛ increase with one another, with a good value achieved at 2.5:1 mL/g and 0.065:1 g/g, respectively. Too small a volume for a given mass may result in a non pumpable fluid with poor mixing efficiencies. Alternately, too large a volume may reduce extraction efficiency by increasing interparticle distances.

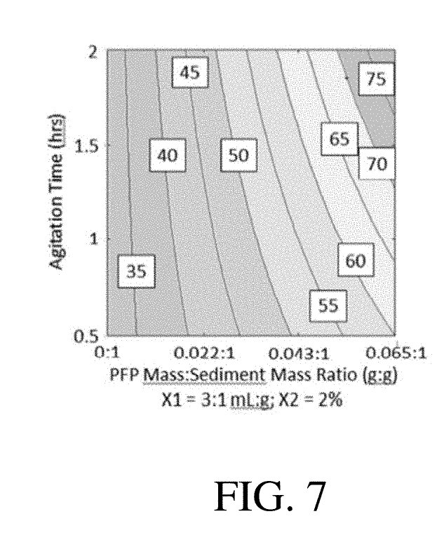

The plot of PFPₘₐₛₛ:Sₘₐₛₛ vs. mixing time, where biosurfactant volume and concentration are constant is shown in FIG. 7. For a given Sₘₐₛₛ, good extraction efficiency is achieved when PFPₘₐₛₛ and mixing time are both increased. As the available polystyrene surface area increases (greater PFP mass), a longer extraction time, up to a maximum of 2 hr, may be helpful to achieve optimum extraction efficiency under model conditions. For example, changing the agitation time in experiment 3 from 2 hr to 10 hr little improvement in recovery was observed (51% to 54%). In contrast, little improvement can be observed after 0.5 hr at low PFPmass. Doubling the PFP mass in experiment 15 increased the extraction efficiency by ˜10%. Removal rates might be balanced against the volume of polystyrene needed to achieve a given recovery. Doubling the mass of PFP greatly increases the volume of sorbent relative to sediment (approximately 6 times).

The surface response model yielded an useful extraction condition of Mᵥₒₗᵤₘₑ:Sₘₐₛₛ 2.5:1 mL/g (0.5), CT1 2% (1), PFPₘₐₛₛ:Sₘₐₛₛ 0.065:1 g/g (1), and mixing time 2 hr (1). Based on these parameters, an 83% reduction in PAH concentration was calculated. Excellent agreement was obtained between predicted and actual (81.4%) amounts, with a RPD of 1.6%. Upon repeating the extraction a second time using fresh PFP, total PAH recovery increased to 94%. Table 3 lists individual PAH concentrations before and after a single treatment under the optimum extraction condition. Interestingly, 2-ring, 3-ring, 4-ring, 5-ring and 6-ring PAH were extracted by the polymer partition system without preference.

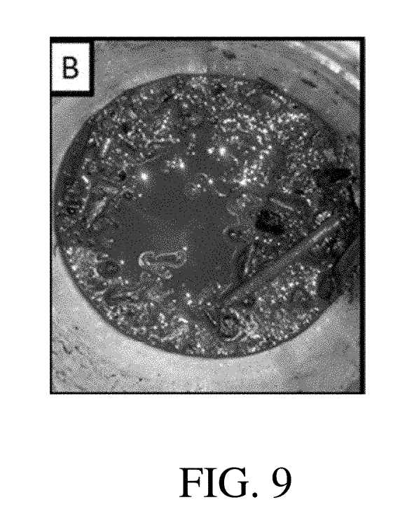

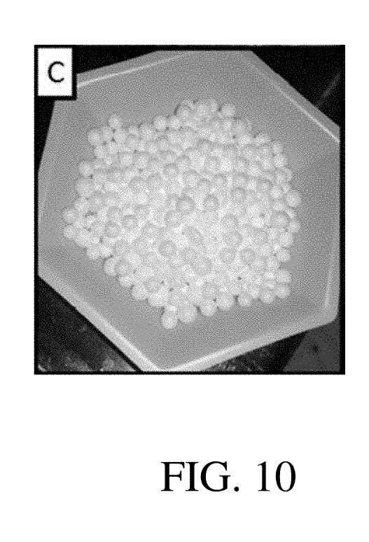

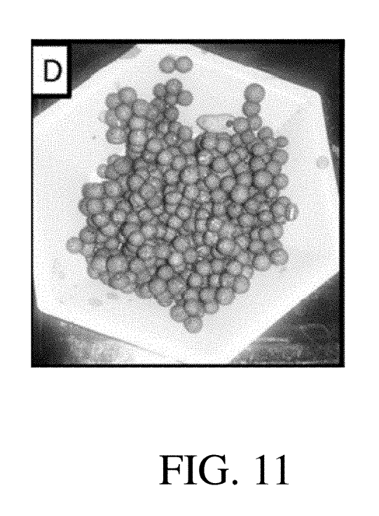

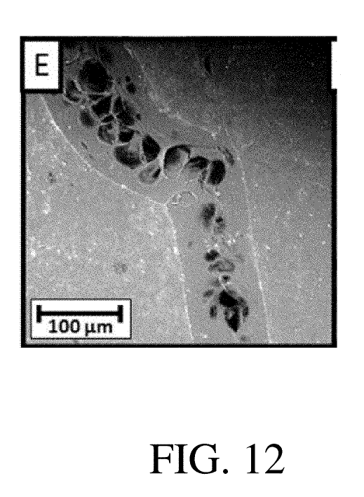

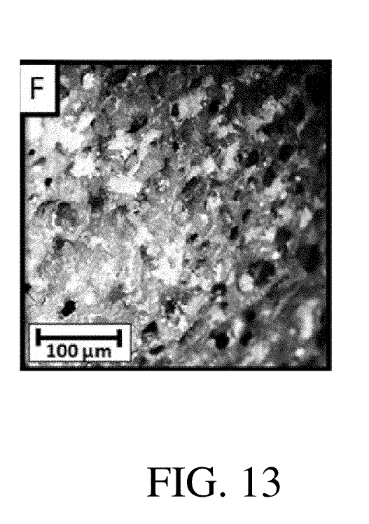

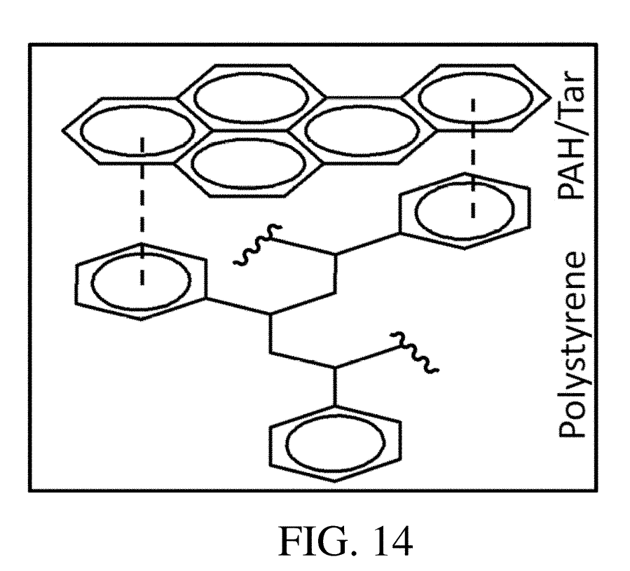

PAH also served as a good estimate of total hydrocarbon removal as exhibited by a 73% decrease in coal tar mass by TSEM, see Table 2, which was only 8.4% different from PAH reduction by GC/MS. Additionally, tar mass removal can be qualitatively observed by the change in sediment color before (black) and after treatment (brown), FIGS. 9 and 10. Mass transfer of tar to PFP is shown in FIGS. 11 and 12, where the dark color change in the PFP beads can be contrasted with the lighter color of the soil after treatment. It is hypothesized that the observed discoloration of PFP, as well as the equivalent removal of TSEM and individual and total PAH is due to tar mobilization followed by sorption of tar particles to PFP. In addition to solubilizing NAPL, surfactants can mobilize NAPL free-product, greatly enhancing remediation efficiency. Since the coal tar is mobilized rather than solubilized, particles of tar should be observable on the foam. SEM images were taken of the PFP surface pre- (FIG. 12) and post-treatment (FIG. 13). Note the smoothness of the untreated polystyrene beads whereas post-treatment beads are far rougher due to collisions with soil particles in the reactor. The dark, patchy accumulation of tar coated the on the surface supports the hypothesis of tar mobilization and free-product release from the sediment. Release of free-product helps to explain the speed at which the biosurfactant enhance polymer partition system operates (hours) as opposed to other polymer partition processes that rely upon diffusional mass transfer (days). Tar may be removed from a river bottom comprising a suspension of coal tar, water and solids and then sorption of tar onto an adsorbent particle (FIG. 14).

Experiments were conducted in the field to evaluate system performance and assess practical aspects of deployment. A portable cement mixer was used to treat 25 kg of sediment. Very close agreement was obtained among field (48±10%, n=3) and lab (51%) experiments, and model predictions (46%). These results demonstrate the accuracy of the model to predict outcomes and treatment tradeoffs.

The high cost and inefficacy of biosurfactants has been a major drawback toward widespread industry adoption. In this case, the sorbent increases efficiency while reducing the amount of biosurfactant needed to achieve a stated hydrocarbon reduction, which makes the process cost-competitive. The estimate of ˜$3.7 million is based on an actual coal tar remediation project based on discussions with contractors for the site owner and the USEPA. These include the operational cost of dredging, stabilizing, and landfilling 10,551 m³ of sediment at the processing rate of 115 m³/day. Since the surfactant/polymer system is a high-throughput process, the cost to treat the same material at 229 m³/day is ˜$2.5 million for a total cost savings of ˜$1.2 million, or 29%. The model was used to predict a system operating condition that would lead to an 80% removal rate. Recall the optimum removal of 81% was achieved using 2% CT1 (model predicted 83%). The cost estimate is based on model predictions of 80% extraction efficiency under the following conditions Mᵥₒₗᵤₘₑ:Sₘₐₛₛ 2.5:1 mL/g (0.5), CT1 1% (0), PFPₘₐₛₛ:Sₘₐₛₛ 0.065:1 g/g (1), and mixing time 2 hr (1), which we achieved in the lab. Since CT1 volume is a significant cost driver, the model was used to trade extraction efficiency vs. cost/benefit.

Additional drivers include the cost of equipment, sorbent, process water and cleanup. For dig and haul, equipment and labor are variable costs and included in the disposal and backfill charges. For the surfactant/polymer process, labor and equipment are shown separately, which include scalper/desander, oil/water separator, mixing tank, centrifuge, and foam thermal densifier. Fixed costs are time dependent. For example, the longer it takes to complete the project the higher the engineering oversight and air monitoring costs will be.

The surfactant/polymer process concentrates tar onto polystyrene, which can be heated or blended with oil to produce fuel oil. Moreover, since tar is separated from sediment, the non-leachable solids can be used as a beneficial reuse material or transported off-site as non-hazardous waste. By heating the tar-sorbed polystyrene on-site to its glass transition temperature (˜100° C.), sorbent volume is reduced by 85%. Further savings are based on recycling water reclaimed from the sediment after centrifugation, which was shown to remove, on average, 75% of water from the soil. Noteworthy is that none of these estimates include potential cost recovery from re-selling reclaimed tar/polystyrene for fuel.

Model predictions can be used to estimate remediation costs. If for example, capping the sediment was acceptable at a 50% tar reduction, 50% cost savings would accrue compared to dig-haul and landfill, including capping costs since the remediation project approved for the river included the addition of sand, clay and cap separately. In this case, operating conditions would be Mᵥₒₗᵤₘₑ:Sₘₐₛₛ 2.2:1 mL/g (0.2), CT1 0% (−1), PFPₘₐₛₛ:Sₘₐₛₛ 0.040:1 g/g (0.1), and mixing time 2 hr (1). On the other hand, should >90% extraction be desired, not only would costs savings fall to 5%, but time increases to process the tar/surfactant emulsion through two polystyrene batches.

### Example 2

This example describes a non-limiting green chemistry solution method for the cleanup of heavy oil derived from a plant-based biopolymer and polystyrene foam beads according to some embodiment. The efficiency of the process was demonstrated through control experiments where water, biopolymer, and sorbent yielded total petroleum hydrocarbon (TPH) reductions of 25%, 52%, and 58%, respectively, compared to 95% for the two-stage reactor after mixing 1% by weight biopolymer with 1:67 g/g of beads and soil for 30 min. Moreover, oil was removed in all soil fractions, with course 97% removal, silt 91%, and clay 75%. Hydrocarbon reduction was independent of molecular weight, since more than 90% of both the diesel and residual-range organics, C13 to C44 were recovered from soil. In addition, the system may employ less sorbent mass, may requires shorter agitation times than other surfactant/polymer partition systems, and can reuse biopolymer process water. Since the biopolymer is sourced from renewable crops and polystyrene from recycled materials, the solution is both efficient and sustainable.

This example describes experiments relating to the ability of the biopolymer/PFP system to extract heavy oil from a highly weathered soil. Toward this end, experiments were conducted with and without biopolymer and/or sorbent. Both treated and untreated samples were analyzed to assess TPH reduction in the sand, silt, and clay fractions.

Weathered soil contaminated with visible quantities of heavy hydrocarbons was obtained from a major oil refiner. Upon receipt, the sample was sieved to remove solids and oil balls >3.36 mm in diameter and stored at −20° C. until used. Sand, silt, and clay composition were determined using laser diffraction analysis before and after treatment by Weatherford Laboratories (Houston, Tex.).

Soxhlet extraction was used to obtain neat oil from 50 g of sample and 200 mL dichloromethane. Sodium sulfate was added to dry the extract. The solvent was evaporated under a gentle stream of nitrogen at 60° C. until the mass was constant, ±0.01 g, for 30 min.

A modified micro syringe method was used to determine oil density. First, the oil was heated to 80° C. for 5 min to lower its viscosity, enabling it to be drawn into a 100 μL syringe. After the syringe was filled, it was cooled to room temperature, 22° C. The needle tip was cleaned and the syringe weighed before and after fluid expulsion. This process was repeated seven times to assess precision. A Brookfield (Middleboro, Mass.) DV1 Digital Viscometer was used to determine the viscosity of the oil at room temperature (25° C.), shear rate=10-100 s−1.

12 mL polypropylene syringes and 1 μm fiber glass filter tips were acquired from MicroLiter Analytical Supplies (Suwanee, Ga.) and Tisch (Cleves, Ohio), respectively. Polystyrene foam beads, density=20 kg/m³, were purchased from Fairfield (Danbury, Conn.). The biopolymer was obtained from GreenStract, LLP (New York, N.Y.). The biopolymer is a mixture of proteins and peptides extracted from corn gluten meal and hemp. Analytical grade dichloromethane and n-hexane were purchased from VWR (Radnor, Pa.), sodium sulfate from Avantor Performance Materials (Canter Valley, Pa.), and Hydromatrix drying agent from Agilent Technologies (Santa Clara, Calif.). Diesel fuel #2 composite standard obtained from Restek (Bellafonte, Pa.) was used to calibrate an Agilent 7890B gas chromatograph/flame ionization detector (GC/FID) for TPH analysis.

Biopolymer-Enhanced Polystyrene Treatment System. A Talboys (Thorofare, N.J.) model 102 laboratory stirrer was used in a completely mixed reactor. 20 g of sample and 25 mL of water (control) or mobilizing agent (1% a.i. biopolymer) were added to a 4 oz threaded glass jar with Teflon-lined cap and agitated using a 2 in diameter impeller blade, positioned just below the slurry meniscus, rotated at 200 rpm for 30 min. Experimental conditions are shown in Table 4. When applicable, a total of 300 mg PFP was added to the completely mixed reactor during agitation.

TABLE 4
Continuously mixed reactor experiments based on 20 g soil and 0.5 hr
agitation.

| Experiment | Aqueous Phase | Sorbent Phase |
|---|---|---|
| 1 | 25 ml Water | None |
| 2 | 25 ml 1% Biosurfactant | None |
| 3 | 25 ml Water | 300 mg PFP |
| 4 | 25 ml 1% Biosurfactant | 30 mg PFP |

After agitation the PFP were skimmed from the reactor using a 16 mesh screen spoon. A gentle stream of deionized water was used to wash fines from the impeller blades and pellets. The sand, silt, and clay fractions were operationally defined by settling time. The sand fraction settled out instantly after agitation. The silt fraction settled after 2 hr and the clay fraction 24 hr thereafter. In some experiments all fractions were allowed to settle for 24 hours before the supernatant was decanted to obtain total “bulk” TPH in the sample. In other experiments, TPH was measured in the sand, silt and clay fractions, separately. A 1 g aliquot of the untreated and treated soils was baked at 95° C. to estimate percent moisture.

The sample extraction method utilized a pressurized liquid extractor from Fluid Management Systems (Watertown, Mass.). TPH analysis was performed according to EPA Method 8015b. A calibration curve was established between 156 μg/mL and 10 mg/mL based on the #2 diesel fuel composite standard. Each analytical batch began with three solvent blanks to ensure a flat baseline, with additional blanks run between each standard and sample to assess sample carryover. A baseline was manually drawn for each calibration and sample chromatogram from the start of the solvent peak to the end of each run. Calibration data files were baseline integrated over the standard diesel range organics (DRO), decane (C10) through octacosane (C28). The calibration factor (CF) was calculated from the curve according to the equation, CF=(total peak area)/concentration, where the average CF of the calibration curve is used to determine TPH in the sample by rearranging the equation. Initial (at the start of the project) and continuing (before and at the end of each day) calibration were acceptable when the average % RSD and % RPD were ≦15%, respectively. The sample was integrated between tridecane (C13) and tetratetracontane (C44). Results are reported on a dry weight basis. All experiments were carried out three-times.

The goal of hazardous waste site remediation projects is to reduce TPH below 1% (10,000 mg/kg) where petroleum or coal tar is the contaminant. A series of batch reactor experiments were performed to evaluate the potential of the biopolymer/polystyrene reactor system to reduce TPH in a weathered soil to meet this metric. Extraction efficiencies were evaluated for the bulk soil and individual fractions (sand, silt and clay). The mechanism of extraction was also investigated.

Laser diffraction analysis of the untreated and biopolymer/PFP treated soil showed more sand in the treated (75%) vs. untreated (66%) samples with a correspondingly lower amount, 19% vs. 28%. of silt observed between the two. Both samples contained 5-6% clay. Analysis of the solvent-extracted oil revealed diesel (C13-C28) and residual (C29-C43) range organics were 57±9% and 43±6%, respectively. Oil viscosity and density were 3525 cP and 0.948±0.013 g/cm³ at 25° C. These values correspond to heavy, winter-grade engine oil (American Petroleum Institute, Society of Automotive Engineers). Table 5 shows the amount of total TPH in the untreated soil (47,400±2,440 mg/kg) and in each fraction (sand: 36,000±4,500 mg/kg, silt: 112,000±21,500 mg/kg, and clay: 81,200±5,450 mg/kg).

TABLE 5
TPH concentrations in bulk soil (n = 5) and sand, silt, and clay fractions (n = 3).

| Experiment | Sample/Treatment | Bulk TPH, mg/kg | Reduction | Fraction | TPH, mg/kg | Reduction |
|---|---|---|---|---|---|---|
| NA | Untreated Sample | 47,400 ± 2,440 | NA | Sand | 36,000 ± 4,500 | NA |
| | | | | Silt | 112,000 ± 21,500 | |
| | | | | Clay | 81,200 ± 5,450 | |
| 1 | Water | 35,700 ± 10,100 | 25 ± 21% | Sand | 18,100 ± 5,790 | 50 ± 16% |
| | | | | Silt | 120,000 ± 15,700 | −7 ± 14% |
| | | | | Clay | 60,300 ± 18,500 | 26 ± 23% |
| 2 | 1% Biopolymer | 22,800 ± 2,600 | 52 ± 5% | Sand | 10,400 ± 6,060 | 71 ± 17% |
| | | | | Silt | 72,600 ± 17,000 | 35 ± 15% |
| | | | | Clay | 63,800 ± 6,820 | 21 ± 8% |
| 3 | Water + PFP | 19,700 ± 6,820 | 58 ± 14% | Sand | 14,800 ± 4,360 | 59 ± 12% |
| | | | | Silt | 14,800 ± 7,740 | 87 ± 7% |
| | | | | Clay | 40,100 ± 15,200 | 51 ± 19% |
| 4 | 1% Biopolymer + | 2,990 ± 2,090 | 94 ± 6% | Sand | 1,020 ± 595 | 97 ± 2% |
| | PFP | | | Silt | 10,200 ± 7,760 | 91 ± 7% |
| | | | | Clay | 20,400 ± 4,180 | 75 ± 5% |

Table 5 also summarizes TPH removal for control experiment 1, which used only water (no biopolymer or PFP pellets). Total soil TPH after water extraction was 35,700±10,100 mg/kg, which corresponds to a 25±21% reduction. Although TPH removal was highest in the sand fraction (50±16%), the TPH concentration of 18,100±5,790 mg/kg exceeded the 1% (i.e., 10,000 mg/kg) metric of success. A total of 26±23% in TPH reduction was measured in the clay fraction (TPH 60,300±18,500 mg/kg) with no removal observed in the silt fraction. These data demonstrate the poor efficiencies obtained when only water is used to remove heavy, viscous oil from soil without the addition of mobilizing agent or solid adsorbent.

Also shown in Table 5 are extraction results for the biopolymer alone (no PFP), see experiment 2. Although the addition of biopolymer improved TPH removal by two-fold compared to water (52±5% TPH reduction), TPH concentration in the bulk material was still high (22,800±2,600 mg/kg). Nonetheless, TPH removal in sand was 71±17% (10,400±6,060 mg/kg). Remarkably, 35±15% (72,600±17,000 mg/kg) and 21±8% (63,800±6,820 mg/kg) TPH removal were observed in the clay and silt fractions, respectively, suggesting release of hydrocarbons employing an inefficient collection process.

To determine optimum sorbent-to-soil ratio, initial experiments were conducted with water and between 5 mg and 25 mg PFP/g soil. The increase in TPH reduction ranged from 37% (1:200 wt PFP per wt soil) to 64% (1:40 wt PFP per wt soil). Since the objective is to obtain a cost effective solution, de minimis improvements occurred above 15 mg PFP/g soil (1:67 g/g). At this ratio, 58±14% TPH reduction (19,700±6,820 mg/kg TPH) in bulk soil was achieved, see Table 5 experiment 3. TPH removal in the fractions were silt 87±7% (14,800±7,740 mg/kg), clay 51±19% (40,100±15,200 mg/kg), and sand 59±12% (14,800±4,360 mg/kg). Although TPH concentration in sand was above the 1% threshold, results can be attributed to un-recovered “oil balls” too big to adhere to PFP. Once the mixing stopped oil balls fall to the bottom of the reactor. Note: 57% of the oil ball was on average solids and the balance oil as determined by methylene chloride extraction.

Also shown in Table 5 are the results of 25 ml 1% biopolymer, 0.300 g PFP, and 20 g soil. Compared to experiments 1-3, experiment 4 achieved significantly higher TPH removal (94±6%), with a TPH in soil of 2,990±2,090 mg/kg. Correspondingly, TPH removals were also obtained for each fraction: 97±2% in sand (1,020±595 mg/kg remaining), 91±7% in silt (10,200±7,760 mg/kg remaining), and 75±5% clay (20,400±4,180 mg/kg remaining). The cleaned sand fraction contains little oil; the remaining hydrocarbon concentration was nearly 10-times below the 10,000 mg/kg success metric. FIG. 15 compares the C13 to C44 untreated and treated soil concentrations. Hydrocarbon removal was, for the most part, independent of size. For example, the system removed 84% of C13-C14 to 98% of C37-C38, a 15% difference. In fact, more than 90% removal was obtained for both the diesel range and residual range organics. These data are consistent with the coal tar/PAH extraction results obtained using similar amounts of biopolymer/PFP. In some cases of the coal tar study, recoveries were independent of aromatic rings and alkylation, since extraction efficiencies were also within 15% of one another. Without wishing to be bound by theory, this may indicate that when surfactants are used without a sorbent, lighter, more soluble hydrocarbons may be removed with greater efficiency than heavier ones.

The biopolymer-enhanced polystyrene partitioning is a two-step mobilization/sorption process. Conceptually, the biopolymer mobilizes hydrocarbons into the “free-phase.” Compared to micellar solubilization, oil (and coal tar) mobilization off of solid matrixes typically increases the release of hydrocarbons independent of size, requiring less time to do so. Once in “free-phase” both aliphatics and aromatics readily sorb onto polystyrene foam pellets via hydrophobic forces.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
agitating a contaminated sample, a surfactant, and adsorbent particles, wherein the contaminated sample comprises a solid or liquid material and organic contaminants; and removing at least a portion of the organic contaminants from the contaminated sample, thereby producing a cleaned sample.

2. The method as in claim 1, wherein the adsorbent particles are adsorbent polymer particles.

3. The method as in claim 1, wherein the contaminated sample comprises one or more of contaminated soil, contaminated water, and contaminated sediment.

4. The method as in claim 1, wherein the organic contaminants comprise one or more of tar, crude oil, polycyclic aromatic hydrocarbons, and other hydrocarbon mixtures.

5. The method as in claim 1, wherein greater than 50% of the organic contaminants are removed from the contaminated sample.

6. The method as in claim 2, wherein the adsorbent polymer particles comprise a polymer with aromatic groups.

7. The method as in claim 2, wherein the adsorbent polymer particles comprise a polymer with an amorphous microstructure.

8. The method as in claim 2, wherein the adsorbent polymer particles comprise one or more of polystyrene, polyethylene, and polypropylene.

9. The method as in claim 2, wherein the adsorbent polymer particles are in the form of a foam.

10. The method as in claim 1, wherein the adsorbent particles are porous.

11. The method as in claim 1, wherein the adsorbent particles have a density less than 1000 kg/m³.

12. The method as in claim 1, wherein the surfactant comprises a biosurfactant.

13. The method as in claim 12, wherein the biosurfactant comprises material derived from plants, bacteria, and/or fungi.

14. The method as in claim 1, wherein the organic contaminants are removed by removing at least a portion of the adsorbent particles.

15. A kit for removing organic contaminants from a contaminated sample, comprising:
a surfactant; and
a plurality of adsorbent particles.

16. The kit as in claim 15, where the adsorbent particles are adsorbent polymer particles.

17. The kit as in claim 15, wherein the adsorbent polymer particles comprise one or more of polystyrene, polyethylene, and polypropylene.

18. The kit as in claim 15, wherein the adsorbent particles are in the form of a foam.

19. The kit as in claim 15, wherein the adsorbent polymer particles are porous

20. The kit as in claim 15, wherein the adsorbent polymer particles have a density less than 1000 kg/m³.

21. The kit as in claim 15, wherein the surfactant comprises a biosurfactant.

22. The kit as in claim 21, wherein the biosurfactant comprises material derived from corn gluten meal and/or hemp.
